(19) United States
(12) Patent Application Publication
(10) Pub. No.: US 2021/0277744 A1
(43) Pub. Date: Sep. 9, 2021

(54) PRESSURE SURGE VALVE

(71) Applicant: Ian Schuur, Conroe, TX (US)

(72) Inventor: Ian Schuur, Conroe, TX (US)

(21) Appl. No.: 16/455,637

(22) Filed: Jun. 27, 2019

Related U.S. Application Data
(60) Provisional application No. 62/690,856, filed on Jun. 27, 2018.

(51) Int. Cl. E21B 34/08

(52) U.S. Cl. CPC E21B 34/08; F16K 17/10

(57) ABSTRACT

A pressure surge valve system comprises a mounting assembly, a closure mechanism, and an activation mechanism. The activation system in the preferred embodiment may comprise of an upper bellow chamber or in an alternative embodiment an upper compensation piston chamber. Both embodiments of the activation mechanism have a corresponding lower chamber to the respective upper chamber and a pilot mechanism, which triggers the activation mechanism to activate the closure mechanism, such as a ball closure, based on ambient pressure.

Priority is claimed from 62/690,856, which is hereby incorporated by reference.

### BACKGROUND

### 1. Field of the Invention

The present invention relates generally to safety valve systems, and more specifically, to a pressure surge safety valve system for active flow control.

### 2. Description of Related Art

Safety valve systems are well known in the art and are effective means to control unplanned well flow, which impact downstream equipment, facilities, and the environment. For example, the major components of a conventional safety valve system are a valve spring preset for a specific flow rate or hydraulic pressure, flow tube, and a closure mechanism. Once the flow rate reaches the critical rate, or predetermined hydraulic pressure is overcome, for the valve spring the flow tube moves up and releases the flapper, or rotates a ball, to close and shut off the flow.

One of the problems commonly associated with a conventional sub-surface safety valve (SSV) system is there are no automatic means to control the unplanned pressure increases experienced in wells in unconventional plays. These pressure increases generated when an adjacent well is stimulated or fractured, also called offset-frac or frac-hit, can negatively impact the completion string, downstream equipment, facilities, and the environment.

Another problem with the use of SSV's in unconventional wells is the rapidly changing conditions of the well. Bottom hole production pressure, production rates, and production mix can change by 50% or more in as little as 3 months requiring a change of the initially installed SSV configuration.

Flow activated conventional safety valves, sometimes called storm chokes, require a minimum amount of flow to actuate the closure mechanism. Oftentimes a well may experience a pressure surge at the well face though the flow through the well is restricted by either completion, surface equipment, or both. Under such conditions the flow activated conventional safety valve will not close.

Hydraulically activated conventional safety valves, sometimes called surface controlled sub-surface safety valves (SCSSV), have a predetermined activation pressure applied at the surface. This activation pressure is defined by the maximum hydrostatic head pressure that the hydraulic system will experience under a loss of control event and cannot be adjusted for changing well conditions once installed.

In addition, the use of conventional safety valve system is an option that has not been accepted for land use due to the application restriction in the use of SSV. While SCSSVs are common in offshore wells due to requirements by regulatory bodies, they have limited life-of-well applicability for land wells, specifically in unconventional plays.

### SUMMARY OF THE INVENTION

The present application is a pressure surge valve (PSv) which offers the same benefits of a SSV without the requirement of hydraulic surface control or production flow and allows for an automatic means to control unplanned pressure increases. The pressure surge valve comprises of an ambient pressure rate increase activated closure mechanism that is independent of the initial ambient pressure.

Accordingly, although great strides have been made in the area of SSVs, many shortcomings remain. The present application PSv addresses these shortcomings by providing an activation mechanism that is not flow rate or surface hydraulic pressure dependent. Instead, the PSv is activated by a pressure surge at the valve. As the PSv is ambient pressure independent, it is not depth limited and can be placed at the well-face, at the lower most point in the well's production string. Also, once activated, the PSv can be opened by pressure balancing across the closure mechanism.

The preferred embodiment of a PSv system with the bellows configuration for the pressure surge valve containing an activation mechanism is comprised of an upper bellows contained chamber, a corresponding lower chamber, a closure mechanism, and a pilot mechanism. During an ambient pressure surge, which exceeds the pilot mechanism regulated rate, the pilot mechanism triggers the activation mechanism to activate the closure mechanism and closing the valve.

An alternative embodiment of a compensating piston configuration for the pressure surge valve containing an activation mechanism is comprised of an upper compensating piston contained chamber, a corresponding lower chamber, a closure mechanism, and a pilot mechanism. During an ambient pressure surge, which exceeds the pilot mechanism regulated rate, the pilot mechanism triggers the activation mechanism to activate the closure mechanism and closing the valve.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a longitudinal cross section of a pressure surge valve system in accordance with a preferred embodiment of the present application;

FIG. 2A is a cross section of the pressure surge valve system in an open position in accordance with a preferred embodiment of the present application;

FIG. 2B is a cross section of the pressure surge valve system in an open position in accordance with a preferred embodiment of the present application;

FIG. 3 is an illustration of a subsection of a pressure surge valve system in accordance with a preferred embodiment of the present application;

FIG. 4 is a depiction of a pressure surge valve system in a tubing string as installed in a well in accordance with a preferred embodiment of the present application;

FIG. 5A is a cross section of a pressure surge valve system in an open position in accordance with an alternative embodiment of the present application; and

FIG. 5B is a cross section of a pressure surge valve system in an open position in accordance with an alternative embodiment of the present application.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional sub-surface safety valve systems. Specifically, the problem of controlling the unplanned pressure increase which impact downstream equipment facilities by using automatic means to control these unplanned events at the point of entry. This is accomplished through the use of the pressure surge valve system which when the pressure at the valve is maintained within a predetermined range the valve remains open. However, when the pressure changes at the valve and exceed the predetermined pressure rate range the valve closes. In addition, because this system is automated and self-contained it does not need to be constantly manned and may operate independently without outside intervention. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

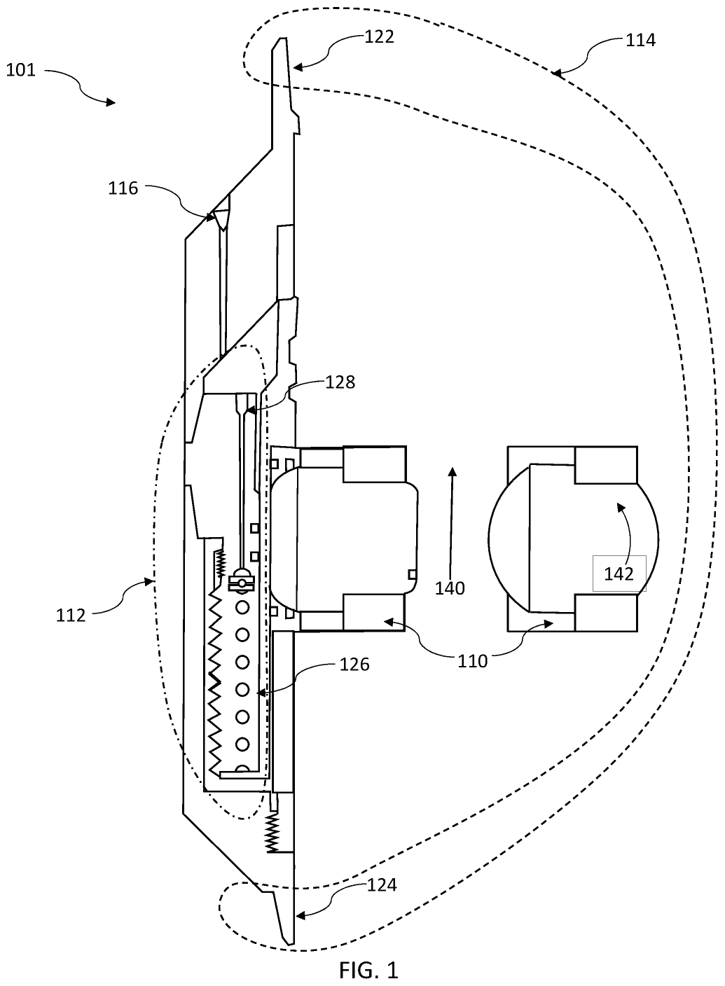

Referring now to the drawings wherein like reference characters identify corresponding or similar elements throughout the several views, FIG. 1 depicts a longitudinal cross section of a pressure surge valve system 101 in accordance with a preferred embodiment of the present application. It will be appreciated that system 101 overcomes one of more of the above-listed problems commonly associated with conventional safety valve systems.

In the contemplated embodiment, system 101 includes a closure mechanism 110; an activation mechanism 112; a mounting assembly 114; and an optional remote secondary activation 116.

System 101 is installed in the flow stream by means of a mounting assembly 114. The mounting assembly comprises of a first and second threaded connection 122, 124. It should be appreciated that in alternative embodiments that alternative means can be used to mount system into the flow stream with the flow direction 140 as depicted. The system 101 is a normally open device that closes when it sees a pressure rate increase, above the activation pressure rate. When closed the device remains in this position, providing a barrier, until the pressure across the valve is balanced.

System 101 has an activation mechanism 112. The activation mechanism 112 comprises of a pressure chamber 126 and a pressure balance feature 128 that can perform in various differential pressure scenarios. Additionally, the activation mechanism 112 can be completely self-contained and exposed to the flow stream environment.

System 101 has a pressure balanced, normally open closure mechanism 110 that is sensitive to differential pressures across the areas. When a pre-determined pressure surge (change in pressure and rate of change) is seen at the pressure chamber 126 it acts across the areas in a way that shifts 142 the closure mechanism 110 and closes the system 101.

In the contemplated embodiment, the pressure required is determined by the areas and the hold open load generated by a spring or facsimile (i.e. loaded bellows). The rate of pressure increases to achieve activation is set by the rate at which the pressure balance feature 128 is allowed to achieve pressure equilibrium.

Once activated, system 101 can be re-opened by applying pressure in the tubing string [not depicted] and equalizing the pressure across the closure mechanism 110. Should it be required, secondary activation may also be applied by the insertion of a mechanical slickline apparatus adjacent to the pressure balance feature 128.

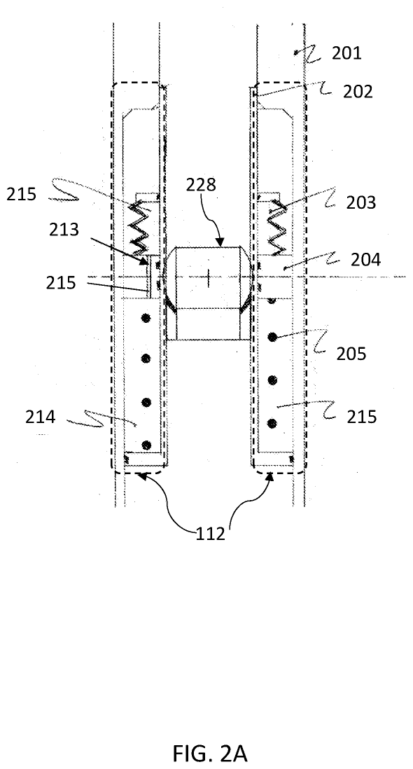

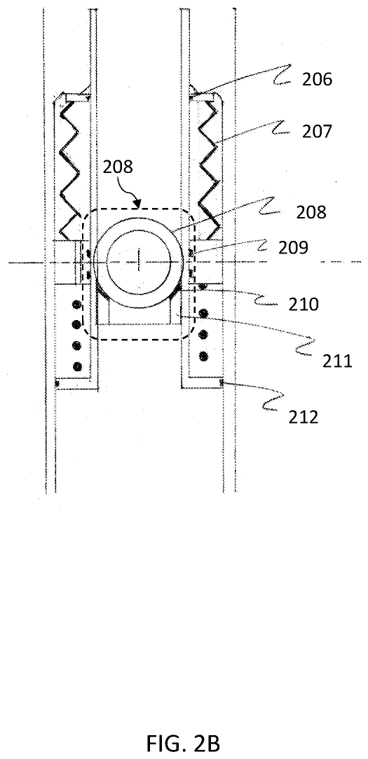

Referring now to FIGS. 2A and 2B which are cross sections of the pressure surge valve system 101, FIG. 2A depicts the system 101 in an open position and FIG. 2B depicts the system 101 in a closed position, both in accordance with a preferred embodiment of the present application. FIG. 2A depicts the activation mechanism 112 of system 101 in more detail. The activation mechanism 112 resides in a valve body 201 and is sheathed by a shifting/extension sleeve 202. The activation mechanism 112 comprises of an upper chamber 203, valve housing 204, and a lower chamber 214.

The upper chamber 203 of the activation mechanism 112 has more stroke than shifting/extension sleeve 202 to compensate for volume transfer from the lower chamber 214. The upper chamber 203 further comprises of bellows 207 where one end is coupled to an upper seal 206 and the other end is coupled to the valve housing 204. In the open position the bellows 207 are compressed and in the closed position the bellows 207 are extended. The upper chamber 203 contains an incompressible fluid 215, such as hydraulic fluid or other similar type fluid.

The valve housing 204 further comprises a pilot mechanism 213 which contains incompressible fluid 215.

The lower chamber 214 piston area is greater than the upper chamber 203 piston area and the shifting sleeve 202 for the upper chamber 203 area combined. The piston area is the face of the chamber 203, 214 seeing the reservoir pressor. The lower chamber 214 further comprises a power spring 205 where one end is coupled to the valve housing 204 and the other end is couple to a lower seal 212. The power spring 205 is extended in the open position and compressed in the closed position. The lower chamber 214 contains incompressible fluid 215, such as hydraulic fluid or other similar type fluid.

The closure mechanism 208 resides in the core of the valve body 201 surrounded by the activation mechanism 112. The closure mechanism 208, which in the preferred embodiment is a ball closure 228, further comprises of a minimum of two housing seals 209, a soft seat 210, and a hard seat 211. In the open position the closure mechanism 208 allows flows to pass through the system 101, while in the close position the closure mechanism 208 rotates and stops the flow.

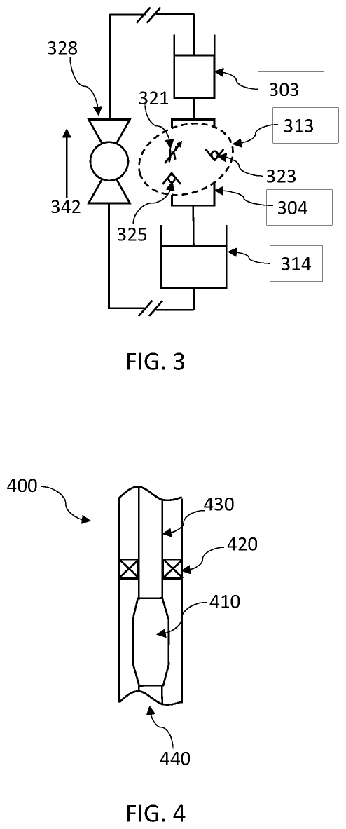

Referring now to FIG. 3 which is an illustration of a subsection of a pressure surge valve system 101 in accordance with a preferred embodiment of the present application. FIG. 3 depicts certain aspects of system 101 in more detail. System 101 comprises of an upper chamber 303, a valve housing 304, and a lower chamber 314.

The valve housing 304 further comprises of a pilot mechanism 313 which has two one-way check valves 323, 325 and a metering valve 321, which are used to control the transfer of incompressible fluid, such as hydraulic fluid or other similar type fluid, between the lower and upper chambers.

FIG. 3 also depicts the shift 342 direct of the ball closure 328 takes when system 101 closes.

As ambient pressure increases pressure differential is established between the well and the lower chamber 314. This differential pressure pushes against the lower chamber piston area pushing the chamber fluid against the one-way check 323. When the check 323 is overcome fluid flows from the lower chamber to the upper chamber 303 activating the activation mechanism to shift 342 and close the closure mechanism 328. When the ambient pressure stabilizes the upper chamber 303 pressure balances to that of the lower chamber 314 across the return check 325, whose flow may be metered by the metering valve 321, returning the activation mechanism to its original position and opening the closure mechanism.

Referencing the PSv depicted in FIG. 3 it may be seen that the activation mechanism could be configured in such a way that its interface between the closure system 328 is other than what is represented. For example, the lower chamber 314, upper chamber 303, and pilot mechanism 313 may be positioned other than concentrically.

Referring now to FIG. 4 which is a depiction of a pressure surge valve system 101 in a tubing string 400 as installed in a well in accordance with a preferred embodiment of the present application. The tube string 400 in installed in producing well where there may be a packer or tubing anchor 420 used after the section of tubing 430 that has production pressure surge valve 410 mounted before the reservoir production flow 440.

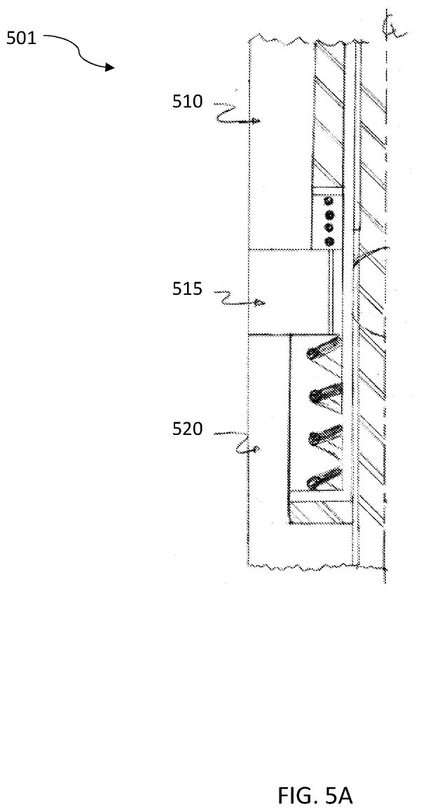

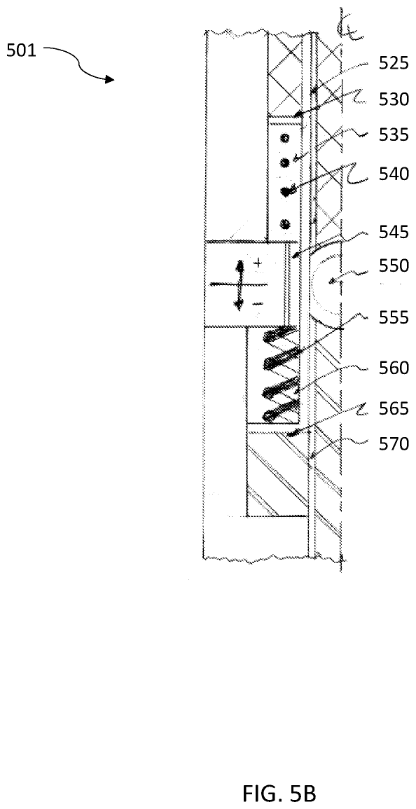

Referring now to FIGS. 5A and 5B which are a cross section of a pressure surge valve system 501 with FIG. 5A in an open position and FIG. 5B in a closed position in accordance with an alternative embodiment of the present application. The alternative system 501 is a non-bellows version of system 101. System 501 comprises of an upper housing 510, a body 515, and a lower housing 520. System 501 further comprises a shifting/extension sleeve 525,

The upper housing 510 incorporates the upper chamber 535 that comprises of a compensating piston 530 that is allowed to travel separate of the lower piston 565. Included in the upper chamber 535 may be a compensating spring 540. Affixed to the upper chamber 535 may be a shifting/extension sleeve 525 that may be used to mechanically shift the activation system.

As in the other embodiments, the compensating piston configuration also has a body 515 that comprises of the pilot metering system 545. The body may also incorporate the closure mechanism 550

The lower housing incorporates the lower chamber 560 that comprises of the lower piston 565 and the power spring 555. Affixed to the lower chamber 560 may be a seating system 570 that engages the closure mechanism 550 when activated.

It should be appreciated that one of the unique features believed characteristic of the present application is conventional control valves incorporate external activation, either by applied hydraulic pressure or mechanical loads or are flow activated as the flow rate increases. An advantage of system 101 is that it responds to changing pressure conditions at the valve, activating when a set of predefined conditions are seen (i.e. 2,500 psi increase in 3 minutes).

The PSv is depicted as being used in an oil and gas well installation. However, this device is not limited to this application and may be suitable for water wells, pipelines, or many other locations where a downstream pressure surge is undesired.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A pressure surge valve system comprising:
a mounting assembly;
a closure mechanism;
an activation mechanism, further comprising of an upper chamber and a pilot mechanism which triggers the activation mechanism to activate the closure mechanism based on ambient pressure; and
a lower chamber.

2. The closure mechanism of claim 1 comprising:
a ball closure;
two housing seals;
a soft seat; and
a hard seat.

3. The pilot mechanism of claim 1 comprising:
a metering valve;
two incompressible fluid transfer controlling one-way check valves.

4. The upper chamber of claim 1, wherein the upper chamber a bellow chamber.

5. The upper chamber of claim 1, wherein the upper chamber is a compensation piston chamber.

6. A pressure activation mechanism comprising:
an upper bellows chamber;
a pilot mechanism which triggers the activation mechanism to activate a closure mechanism based on ambient pressure: and
a lower chamber.

7. A compensating piston configuration activation mechanism comprising:
an upper compensation piston chamber:
a pilot mechanism which triggers the activation mechanism to activate a closure mechanism based on ambient pressure; and
a lower chamber.
